(19) United States
(12) Patent Application Publication
(10) Pub. No.: US 2026/0132287 A1
(43) Pub. Date: May 14, 2026

(54) THERMOPLASTIC COMPOSITION, METHOD FOR THE MANUFACTURE THEREOF, AND ARTICLES COMPRISING THE COMPOSITION

(71) Applicant: SHPP GLOBAL TECHNOLOGIES B.V., Bergen op Zoom (NL)

(72) Inventors: Haiming Chen, Shanghai (CN); Xiaoming Jiang, Shanghai (CN)

(21) Appl. No.: 19/118,671

(22) PCT Filed: Sep. 18, 2023
(86) PCT No.: PCT/IB2023/059245

§ 371 Date: Apr. 4, 2025

(30) Foreign Application Priority Data
Oct. 7, 2022 (EP) 22200306.3

(51) Int. Cl. C08L 77/06; C08L 71/12; C08L 77/12

(52) U.S. Cl. CPC C08L 77/06; C08L 71/12; C08L 77/12; C08L 2205/03

(57) ABSTRACT

A molded article includes a composition having particular amounts of a polyamide, a polyphenylene ether, and a polyetherester amide. The molded article may be an automotive component. Methods for the manufacture of the composition and articles made from the composition are also disclosed.

### CROSS REFERENCE TO RELATED APPLICATION

This application claims priority to and the benefit of European Patent Application No. 22200306.3, filed on Oct. 7, 2022, the content of which is hereby incorporated by reference in its entirety.

### BACKGROUND

Dielectric performance is one consideration in selecting suitable plastic materials for use in electronics and telecommunication applications. It would be desirable to provide materials suitable for exposure to high frequency environments (e.g., in the range of 10-100 GHz). Polymeric materials with a higher dielectric constant (Dk) and dissipation factor (Df) will absorb substantially more electromagnetic energy, affecting the strength and phase of the electromagnetic wave.

In addition to dielectric performance, however, plastics for use in such components should also have certain mechanical performance characteristics including high modulus and high impact strength. Improved mechanical performance can be imparted to polymeric materials by the addition of fillers such as glass fiber, carbon fiber and ceramics. However, typical fillers tend towards elevated dielectric performance (Dk and Df) properties.

Thus, there is a continuing need for new compositions that can address the above-described technical limitations. Specifically, it would be particularly useful to provide a composition having good dielectric performance while also maintaining good mechanical properties and color. Such compositions would be particularly well suited for automotive applications.

### SUMMARY

A molded article comprises a composition comprising 25 to 77 weight percent of a polyamide; 20 to 45 weight percent of a polyphenylene ether; 3 to 30 weight percent of a polyetherester amide; wherein weight percent of each component is based on the total weight of the composition; wherein the molded article is an automotive component; and wherein the molded article exhibits: a heat deflection temperature of 120° C. or more, determined according to ASTM D648; a surface resistivity of 10⁸ ohm/sq to 10¹³ ohm/sq, determined according to ASTM D257; a dielectric constant less than 4, determined using QWED split post dielectric resonator and Agilent PNA network analyzer; a flexural modulus of 1200 MPa or more, determined according to ASTM D790; and a parasitic capacitance of less than or equal to 0.2 pF; determined using a capacitor signal detector at 100 kHz and 1 volt.

The above described and other features are exemplified by the following detailed description.

### DETAILED DESCRIPTION

The present inventors have discovered that a composition comprising particular amounts of a compatibilized blend of polyamide, polyphenylene ether, and a polyetherester amide can advantageously provide a desirable combination of light color, low surface resistance, low volume resistance, and good mechanical properties, and thus can be particularly useful for the preparation of molded articles. Exemplary molded articles can include various automotive components. The composition of the present disclosure can further comprise a continuous phase comprising the polyamide and the polyetherester amide and a dispersed phase comprising the polyphenylene ether.

Accordingly, an aspect of the present disclosure is a molded article comprising a composition comprising a polyamide, a polyphenylene ether, and a polyetherester amide.

Polyamides, also known as nylons, are characterized by the presence of a plurality of amide (—C(O) NH—) groups and are described in U.S. Pat. No. 4,970,272 to Gallucci. The polyamide can include aliphatic polyamides, aromatic polyamides, semi-aromatic polyamides, polyamide elastomers, and mixtures thereof. In an aspect, the polyamide comprises an aromatic polyamide. In an aspect, the polyamide comprises a poly (C₁₋₁₂ alkylene dicarboxylate). Specific polyamides include polyamide 6, polyamide-6,6, polyamide-4, polyamide-4,6, polyamide-12, polyamide-6,10, polyamide-6,9, polyamide-6, 12, amorphous polyamides, polyamide 6/6T and polyamide 6,6/6T with triamine contents below 0.5 weight percent, polyamide-9T, polyamide-10,10, polyphthalamide, and combinations thereof. In an aspect, the polyamide comprises a polyamide-6, polyamide-6,6, or a mixture thereof. In an aspect, the polyamide comprises a polyamide-6,6. In an aspect, the polyamide comprises a polyamide-6. In an aspect, the polyamide comprises a polyamide-6 and a polyamide-6,6. Polyamides are commercially available from a variety of sources.

The polyamide can have a glass transition temperature (Tg) greater than or equal to 30° C., or, greater than or equal to 35° C. Within this range the Tg can be 30 to 60° C. The polyphthalamide can also have a melting temperature (Tm) of 170 to 330° C. Within this range the Tm can be greater than or equal to 175° C. Also within this range the Tm can be less than or equal to 300° C.

In an aspect, the polyamide comprises a polyphthalamide. Polyphthalamides comprise repeating units having the formula

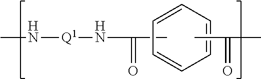

wherein Q¹ is independently at each occurrence a branched or unbranched alicyclic C₄₋₈ alkyl group. In an aspect, Q¹ is independently at each occurrence a 1,6-hexyl group. Polyphthalamides are the condensation product of terephthalic acid and an amine, isophthalic acid and an amine or a combination of terephthalic acid, isophthalic acid and an amine. When employing more than one diamine the ratio of the diamines can affect some of the physical properties of the resulting polymer such as the melt temperature. When employing more than one acid, the ratio of the acids can affect some of the physical properties of the resulting polymer as well. The ratio of diamine to dicarboxylic acid is typically equimolar although excesses of one or the other can be used to determine the end group functionality. In addition the reaction can further include monoamines and monocarboxylic acids which function as chain stoppers and determine, at least in part, the end group functionality. In some embodiments it is preferable to have an amine end group content of greater than or equal to about 30 milliequivalents per gram (meq/g), or, more specifically, greater than or equal to about 40 meq/g.

In an aspect the polyphthalamide can be a block copolymer or a random copolymer further comprising units of the formula

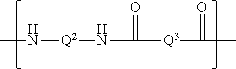

wherein Q² and Q³ are independently at each occurrence a branched or unbranched alicyclic C₄₋₁₂ alkyl group. Q² and Q³ can be the same or different alicyclic C₄₋₁₂ alkyl group.

When the polyamide is a polyphthalamide, the glass transition temperature (Tg) can be greater than or equal to 80° C. or, greater than or equal to 100° C., or, greater than or equal to 120° C. The polyphthalamide can also have a melting temperature (Tm) of 290 to 330° C. Within this range the Tm can be greater than or equal to 300° C. Also within this range the Tm can be less than or equal to 325° C.

The polyamide can be present in an amount of 25 to 77 weight percent, based on the total weight of the composition. Within this range, the amount of the polyamide can be greater than or equal to 27 weight percent, or greater than or equal to 30 weight percent. Also within this range, the amount of the polyamide can be less than or equal to 75 weight percent, or less than or equal to 65 weight percent, or less than or equal to 60 weight percent, or less than or equal to 55 weight percent, or less than or equal to 50 weight percent. In an aspect, the polyamide can be present in an amount of 30 to 60 weight percent, or 40 to 60 weight percent, or 35 to 45 weight percent, or 35 to 42 weight percent, or 30 to 55 weight percent, or 30 to 50 weight percent, or 35 to 50 weight percent, or 40 to 50 weight percent.

In addition to the polyamide, the composition comprises a polyphenylene ether. Suitable polyphenylene ethers include those comprising repeating structural units having the formula

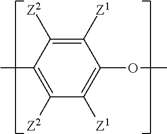

wherein each occurrence of Z¹ is independently halogen, unsubstituted or substituted C₁₋₁₂ hydrocarbyl provided that the hydrocarbyl group is not tertiary hydrocarbyl, C₁₋₁₂ hydrocarbylthio, C₁₋₁₂ hydrocarbyloxy, or C₂₋₁₂ halohydrocarbyloxy wherein at least two carbon atoms separate the halogen and oxygen atoms; and each occurrence of Z² is independently hydrogen, halogen, unsubstituted or substituted C₁₋₁₂ hydrocarbyl provided that the hydrocarbyl group is not tertiary hydrocarbyl, C₁₋₁₂ hydrocarbylthio, C₁₋₁₂ hydrocarbyloxy, or C₂₋₁₂ halohydrocarbyloxy wherein at least two carbon atoms separate the halogen and oxygen atoms. As one example, Z¹ can be a di-n-butylaminomethyl group formed by reaction of a terminal 3,5-dimethyl-1,4-phenyl group with the di-n-butylamine component of an oxidative polymerization catalyst.

The polyphenylene ether can comprise molecules having aminoalkyl-containing end group(s), typically located in a position ortho to the hydroxy group. Also frequently present are tetramethyldiphenoquinone (TMDQ) end groups, typically obtained from 2,6-dimethylphenol-containing reaction mixtures in which tetramethyldiphenoquinone by-product is present. The polyphenylene ether can be in the form of a homopolymer, a copolymer, a graft copolymer, an ionomer, or a block copolymer, as well as combinations thereof.

In an aspect, the polyphenylene ether can have an intrinsic viscosity of 0.25 to 1 deciliter per gram measured by Ubbelohde viscometer at 25° C. in chloroform. Within this range, the polyphenylene ether intrinsic viscosity can be 0.3 to 0.65 deciliter per gram, more specifically 0.35 to 0.5 deciliter per gram, even more specifically 0.4 to 0.5 deciliter per gram.

In an aspect, the polyphenylene ether can comprise a homopolymer or copolymer of monomers selected from the group consisting of 2,6-dimethylphenol, 2,3,6-trimethylphenol, and combinations thereof. In an aspect, the polyphenylene ether can comprise a poly (2,6-dimethyl-1,4-phenylene ether) having an intrinsic viscosity of 0.35 to 0.5 deciliter per gram, specifically 0.4 to 0.5 deciliter per gram, measured at 25° C. in chloroform. Suitable polyphenylene ether homopolymers are commercially available as, for example, PPO™ 640 and 646 from SABIC, and XYRON™ S201A and S202A from Asahi Kasei Chemicals Corporation.

The polyphenylene ether can be prepared by the oxidative coupling of monohydroxyaromatic compound(s) such as 2,6-xylenol and/or 2,3,6-trimethylphenol. Catalyst systems are generally employed for such coupling; they can contain heavy metal compound(s) such as a copper, manganese or cobalt compound, usually in combination with various other materials such as a secondary amine, tertiary amine, halide or combination of two or more of the foregoing.

The polyphenylene ether can have a number average molecular weight of 3,000 to 40,000 grams per mole (g/mol) and a weight average molecular weight of 5,000 to 80,000 g/mol, as determined by gel permeation chromatography using monodisperse polystyrene standards, a styrene divinyl benzene gel at 40° C. and samples having a concentration of 1 milligram per milliliter of chloroform.

The composition can include the polyphenylene ether in an amount of 20 to 45 weight percent, based on the total weight of the composition. Within this range, the amount of the polyphenylene ether can 23 to 40 weight percent or 23 to 35 weight percent, or 35 to 45 weight percent, or 25 to 35 weight percent.

In addition to the polyamide and the polyphenylene ether, the composition further includes a polyetherester amide. Without wishing to be bound by theory, it is believed that the polyetherester amide can act as a polymeric antistatic agent and can unexpectedly provide compositions having conductivity that is comparable to when a conductive filler (e.g., a conductive carbon filler) is used.

Suitable polyetherester amides can be polyamide elastomers comprising a hard segment and a soft segment. The hard segment comprises a polyamide, which can be as described above. The soft segment can comprise a polyalkylene oxide, for example a polyalkylene glycol. Suitable polyalkylene glycol moieties can include, for example, polyethylene glycol, polypropylene glycol, polytetramethylene glycol, and the like. In a specific aspect, the polyetherester amide can comprise a polyamide 6 segment and a poly (ethylene oxide) segment. Suitable polyetherester amides include, for example, those that are commercially available under the tradenames PELESTAT (e.g., PELESTAT 6500) or PELECTRON (e.g., PELECTRON AS), each available from Sanyo Chemical Industries, PEBAX MH1657 commercially available from Atofina, and IRGASTAT P18 and P22, commercially available from Ciba-Geigy.

The polyetherester amide can be present in the composition in an amount of 3 to 30 weight percent, based on the total weight of the composition. Within this range, the polyetherester amide can be present in an amount of 5 to 30 weight percent, or 5 to 25 weight percent, or 5 to 20 weight percent, or 5 to 15 weight percent, or 8 to 30 weight percent, or 8 to 25 weight percent, or 8 to 20 weight percent, or 9 to 30 weight percent, or 9 to 25 weight percent, or 9 to 20 weight percent, or 10 to 30 weight percent, or 10 to 25 weight percent, or 10 to 20 weight percent, or 12 to 20 weight percent, or 10 to 25 weight percent, or 12 to 25 weight percent, each based on the total weight of the composition.

In an aspect, the composition can comprise 30 to 70 weight percent of the polyamide; 27 to 40 weight percent of the polyphenylene ether; and 3 to 18 weight percent of the polyetherester amide. In an aspect, the composition can comprise 40 to 60 weight percent of the polyamide; 35 to 45 weight percent of the polyphenylene ether; and 5 to 17 weight percent of the polyetherester amide.

The composition can further include various additives ordinarily incorporated into polymer compositions of this type, with the proviso that the additive(s) are selected so as to not significantly adversely affect the desired properties of the thermoplastic composition. Such additives can be mixed at a suitable time during the mixing of the components for forming the composition. Additives include impact modifiers, fillers, reinforcing agents, antioxidants, heat stabilizers, light stabilizers, ultraviolet (UV) light stabilizers, plasticizers, lubricants, mold release agents, antistatic agents, colorants such as such as titanium dioxide, carbon black, and organic dyes, surface effect additives, radiation stabilizers, flame retardants, and anti-drip agents. In general, the additives are used in the amounts generally known to be effective. For example, the total amount of the additives (other than any impact modifier, filler, or reinforcing agents) can be 0.01 to 5 wt. %, based on the total weight of the polycarbonate composition.

In an aspect, the composition can include one or more of a reinforcing filler, a compatibilizing agent, and an antioxidant.

Possible fillers or reinforcing agents include, for example, silicates and silica powders such as aluminum silicate (mullite), synthetic calcium silicate, zirconium silicate, fused silica, crystalline silica graphite, natural silica sand, or the like; boron powders such as boron-nitride powder, boron-silicate powders, or the like; oxides such as TiO₂, aluminum oxide, magnesium oxide, or the like; calcium sulfate (as its anhydride, dihydrate or trihydrate); calcium carbonates such as chalk, limestone, marble, synthetic precipitated calcium carbonates, or the like; talc, including fibrous, modular, needle shaped, lamellar talc, or the like; wollastonite; surface-treated wollastonite; glass spheres such as hollow and solid glass spheres, silicate spheres, cenospheres, aluminosilicate (armospheres), or the like; kaolin, including hard kaolin, soft kaolin, calcined kaolin, kaolin comprising various coatings known in the art to facilitate compatibility with the polymer matrix, or the like; single crystal fibers or “whiskers” such as silicon carbide, alumina, boron carbide, iron, nickel, copper, or the like; fibers (including continuous and chopped fibers) such as asbestos, carbon fibers, glass fibers, such as E, A, C, ECR, R, S, D, or NE glasses, or the like; sulfides such as molybdenum sulfide, zinc sulfide or the like; barium compounds such as barium titanate, barium ferrite, barium sulfate, heavy spar, or the like; metals and metal oxides such as particulate or fibrous aluminum, bronze, zinc, copper and nickel or the like; flaked fillers such as glass flakes, flaked silicon carbide, aluminum diboride, aluminum flakes, steel flakes or the like; fibrous fillers, for example short inorganic fibers such as those derived from blends comprising at least one of aluminum silicates, aluminum oxides, magnesium oxides, and calcium sulfate hemihydrate or the like; natural fillers and reinforcements, such as wood flour obtained by pulverizing wood, fibrous products such as cellulose, cotton, sisal, jute, starch, cork flour, lignin, ground nut shells, corn, rice grain husks or the like; organic fillers such as polytetrafluoroethylene; reinforcing organic fibrous fillers formed from organic polymers capable of forming fibers such as poly (ether ketone), polyimide, polybenzoxazole, poly (phenylene sulfide), polyesters, polyethylene, aromatic polyamides, aromatic polyimides, polyetherimides, polytetrafluoroethylene, acrylic polymers, poly (vinyl alcohol) or the like; as well as additional fillers and reinforcing agents such as mica, clay, feldspar, flue dust, fillite, quartz, quartzite, perlite, tripoli, diatomaceous earth, carbon black, or the like, or a combination thereof.

The fillers and reinforcing agents can be coated with a layer of metallic material to facilitate conductivity, or surface treated with silanes to improve adhesion and dispersion with the polymer matrix. In addition, the reinforcing fillers can be provided in the form of monofilament or multifilament fibers and can be used individually or in combination with other types of fiber, through, for example, co-weaving or core/sheath, side-by-side, orange-type or matrix and fibril constructions, or by other methods known to one skilled in the art of fiber manufacture. Co-woven structures include glass fiber-carbon fiber, carbon fiber-aromatic polyimide (aramid) fiber, and aromatic polyimide fiberglass fiber or the like. Fibrous fillers can be supplied in the form of, for example, rovings, woven fibrous reinforcements, such as 0-90 degree fabrics or the like; non-woven fibrous reinforcements such as continuous strand mat, chopped strand mat, tissues, papers and felts or the like; or three-dimensional reinforcements such as braids.

In an aspect, the reinforcing filler can comprise glass fibers. In an aspect, the glass fibers can comprise E, S, AR, T, D, or R glass. The glass fibers can be made, for example, by steam or air blowing, flame blowing, and mechanical pulling. The glass fibers can be sized or unsized. Sized glass fibers can be coated on their surfaces with a sizing composition selected for compatibility with the composition of the present disclosure. Without wishing to be bound by theory, the sizing composition is believed to facilitate wetting of the polyamide and polyphenylene ether upon the fiber strands and assist in attaining desired physical properties in the composition. In an aspect, the glass fibers can be sized with a coating agent. For example, the coating agent can be present in an amount of 0.1 to 5 wt % based on the weight of the glass fibers, or 0.1 to 2 wt % based on the weight of the glass fibers. In preparing the glass fibers, a number of filaments can be formed simultaneously, sized with the coating agent, and then bundled into a strand. Alternatively, the strand itself can be first formed of filaments and then sized. The amount of sizing employed can be an amount which is sufficient to bind the glass filaments into a continuous strand and can be, for example, 0.1 to 5 wt %, or 0.1 to 5 wt %, or 0.1 to 2 wt %, or 0.1 to 2 wt %, each based on the weight of the glass fibers.

The glass fibers can be continuous or chopped. In an aspect, the glass fiber can be chopped. Glass fibers in the form of chopped strands can have a length of, for example, 0.3 millimeters (mm) to 10 centimeters (cm) or 0.5 mm to 5 cm or 0.5 millimeter to 5 centimeters, or 1.0 mm to 2.5 cm, or 0.2 to 20 mm, or 0.2 to 10 mm, or 0.7 to 7 mm, or 0.7 to 7 mm.

The glass fiber can have a round (or circular), flat, or irregular cross-section. In an aspect, the glass fiber can have a circular cross-section. In an aspect, the diameter of the glass fiber can be 1 to 20 micrometers (micron, um), or 4 to 15 um, or 1 to 15 um, or 7 to 15 um.

When present, the reinforcing filler can be included in the composition in an amount of up to 30 weight percent, for example 5 to 30 weight percent, based on the total weight of the composition. Within this range, the filler can be included in an amount of 5 to 25 weight percent, or 7 to 23 weight percent, or 8 to 22 weight percent, or 10 to 20 weight percent, each based on the total weight of the composition.

In an aspect, the composition can comprise 30 to 60 weight percent of the polyamide; 23 to 35 weight percent of the polyphenylene ether; 10 to 25 weight percent of the polyetherester amide; and 5 to 25 weight percent of a reinforcing filler.

In an aspect, the composition can comprise 30 to 70 weight percent of the polyamide; 25 to 40 weight percent of the polyphenylene ether; 5 to 20 weight percent of the polyetherester amide; and optionally, 5 to 25 weight percent of a reinforcing filler.

The composition can further comprise a compatibilizer, also referred to as a compatibilizing agent. Without wishing to be bound by theory, the compatibilizer can improve the miscibility between the polyamide and the polyphenylene ether phases of the composition. The term “compatibilizers” as used herein refers to a polyfunctional compound which can interact with the polyphenylene ether, the polyamide, or both. This interaction can be chemical (e.g., grafting) or physical (e.g., affecting the surface characteristics of the dispersed phases). The resulting compatibilized composition can exhibit improved compatibility, particularly as evidenced by enhanced impact strength, mold knit line strength or elongation. In an aspect, the composition of the present disclosure is a compatibilized composition which has been physically and/or chemically compatibilized with a compatibilizer.

In an aspect, the compatibilizer can comprise a polyfunctional compound have both a carbon-carbon double bond and at least one carboxylic acid, anhydride, epoxy, imide, amide, or ester group, or a functional equivalent thereof. Examples of such polyfunctional compounds can include maleic acid; maleic anhydride; fumaric acid; maleic hydrazide; dichloromaleic anhydride; and unsaturated dicarboxylic acids (e.g., acrylic acid, butenoic acid, methacrylic acid, t-ethylacrylic acid, pentenoic acid, and the like).

In an aspect, the compatibilizer can comprise a polyfunctional compound having both a group of the formula (OR), wherein R is hydrogen or a C₁₋₁₂ alkyl, C₆₋₂₀ aryl, C₂₋₁₂ acyl or carbonyl dioxy group, and at least two groups each of which can be the same or different selected from carboxylic acid, acid halide, anhydride, acid halide anhydride, ester, orthoester, amide, imido, amino, and salts thereof. Examples of this type of compatibilizer can include aliphatic polycarboxylic acids, acid esters and acid amides represented by the formula (R_{I}O)ₘR(COOR^{II})ₙ(CONR^{III}R^{IV})ₛ, wherein R is a linear or branched chain saturated C₂₋₂₀ aliphatic hydrocarbon; R¹ is hydrogen or a C₁₋₁₀ alkyl, C₆₋₂₀ aryl, C₂₋₁₀ acyl or carbonyl dioxy group; each R^{II} is independently hydrogen or a C₁₋₁₀ alkyl or C₆₋₂₀ aryl group; each R^{III} and R^{IV} are independently hydrogen or C₁₋₁₀ alkyl or C₆₋₂₀ aryl group; m is equal to 1 and (n+s) is greater than or equal to 2, or, more specifically, equal to 2 or 3, and n and s are each greater than or equal to zero and wherein (OR) is alpha or beta to a carbonyl group and at least two carbonyl groups are separated by 2 to 6 carbon atoms.

Suitable polycarboxylic acids include, for example, citric acid, malic acid, agaricic acid; including the various commercial forms thereof, such as the anhydrous and hydrated acids; and combinations comprising one or more of the foregoing. In an aspect, the functionalizing agent comprises citric acid. Illustrative esters useful herein include, for example, acetyl citrate and mono and/or distearyl citrates and the like. Suitable amides useful herein can include, for example, N,N-diethyl citric acid amide; N-phenyl citric acid amide; N-dodecyl citric acid amide; N,N-didodecyl citric acid amide and N-dodecyl malic acid. Derivatives include the salts thereof, including the salts with amines and the alkali and alkaline metal salts. Exemplary suitable salts can include calcium malate, calcium citrate, potassium malate, and potassium citrate.

The foregoing compatibilizing agents can be added directly to the melt blend or pre-reacted with one or more of the components of the composition (e.g., either or both of the polyphenylene ether and polyamide). In an aspect, at least a portion of the compatibilizing agent can be pre-reacted, either in the melt or in a solution of a suitable solvent, with all or a part of the polyphenylene ether. It is believed that such pre-reacting can cause the compatibilizing agent to react with the polymer and, consequently, functionalize the polyphenylene ether. For example, the polyphenylene ether can be pre-reacted with maleic anhydride, fumaric acid or citric acid to form an anhydride or acid functionalized polyphenylene ether which can have improved compatibility with the polyamide compared to a corresponding non-functionalized polyphenylene ether.

The amount of the compatibilizing agent used can be dependent upon the specific compatibilizing agent chosen and the specific polymeric system to which it is added. In an aspect, the compatibilizing agent can be present in the composition in an amount of 0.05 to 2.0 weight percent, based on the total weight of the composition. Within this range the amount of compatibilizing agent can be greater than or equal to 0.1 weight percent, or, more specifically, greater than or equal to 0.2 weight percent, or, more specifically, greater than or equal to 0.3 weight percent. Also within this range the amount of compatibilizing agent can be less than or equal to 1.85 weight percent, or, more specifically, less than or equal to 1.5 weight percent, or, more specifically less than or equal to 0.9 weight percent.

Antioxidant additives include organophosphites such as tris (nonyl phenyl) phosphite, tris(2,4-di-t-butylphenyl) phosphite, bis(2,4-di-t-butylphenyl) pentaerythritol diphosphite, distearyl pentaerythritol diphosphite; alkylated monophenols or polyphenols; alkylated reaction products of polyphenols with dienes, such as tetrakis [methylene (3,5-di-tert-butyl-4-hydroxyhydrocinnamate)] methane; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl) propionate, pentaerythrityl-tetrakis [3-(3,5-di-tert-butyl-4-hydroxyphenyl) propionate; amides of beta-(3,5-di-tert-butyl-4-hydroxyphenyl)-propionic acid, or a combination thereof. Antioxidants can be used in amounts of 0.01 to 0.1 parts by weight, based on 100 parts by weight of the total composition, excluding any filler.

The composition can further include an impact modifier. The impact modifier is preferably a hydrogenated block copolymer of an alkenyl aromatic monomer and a conjugated diene. For brevity, this component is referred to as the “hydrogenated block copolymer”. The hydrogenated block copolymer can comprise 10 to 90 weight percent of poly (alkenyl aromatic) content and 90 to 10 weight percent of hydrogenated poly (conjugated diene) content, based on the weight of the hydrogenated block copolymer. In an aspect, the hydrogenated block copolymer can be a low poly (alkenyl aromatic content) hydrogenated block copolymer in which the poly (alkenyl aromatic) content is 10 to less than 40 weight percent, or 20 to 35 weight percent, or 25 to 35 weight percent, yet or 30 to 35 weight percent, all based on the weight of the low poly (alkenyl aromatic) content hydrogenated block copolymer. In an aspect, the hydrogenated block copolymer can be a high poly (alkenyl aromatic content) hydrogenated block copolymer in which the poly (alkenyl aromatic) content is 40 to 90 weight percent, or 50 to 80 weight percent, or 60 to 70 weight percent, all based on the weight of the high poly (alkenyl aromatic content) hydrogenated block copolymer.

In an aspect, the hydrogenated block copolymer can have a weight average molecular weight of 40,000 to 400,000 grams per mole. The number average molecular weight and the weight average molecular weight can be determined by gel permeation chromatography and based on comparison to polystyrene standards. In an aspect, the hydrogenated block copolymer can have a weight average molecular weight of 200,000 to 400,000 grams per mole, or 220,000 to 350,000 grams per mole. In an aspect, the hydrogenated block copolymer can have a weight average molecular weight of 40,000 to 200,000 grams per mole, or 40,000 to 180,000 grams per mole, or 40,000 to 150,000 grams per mole.

The alkenyl aromatic monomer used to prepare the hydrogenated block copolymer can have the structure

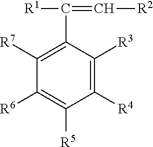

wherein R¹ and R² each independently represent a hydrogen atom, a C₁₋₈ alkyl group, or a C₂₋₈ alkenyl group; R³ and R⁷ each independently represent a hydrogen atom, a C₁₋₈ alkyl group, a chlorine atom, or a bromine atom; and R⁴, R⁵, and R⁶ each independently represent a hydrogen atom, a C₁₋₈ alkyl group, or a C₂₋₈ alkenyl group, or R⁴ and RS are taken together with the central aromatic ring to form a naphthyl group, or R⁵ and R⁶ are taken together with the central aromatic ring to form a naphthyl group. Specific alkenyl aromatic monomers include, for example, styrene, chlorostyrenes such as p-chlorostyrene, methylstyrenes such as alpha-methylstyrene and p-methylstyrene, and t-butylstyrenes such as 3-t-butylstyrene and 4-t-butylstyrene. In some embodiments, the alkenyl aromatic monomer is styrene.

The conjugated diene used to prepare the hydrogenated block copolymer can be a C₄₋₂₀ conjugated diene. Suitable conjugated dienes include, for example, 1,3-butadiene, 2-methyl-1,3-butadiene, 2-chloro-1,3-butadiene, 2,3-dimethyl-1,3-butadiene, 1,3-pentadiene, 1,3-hexadiene, and the like, and combinations thereof. In an aspect, the conjugated diene is 1,3-butadiene, 2-methyl-1,3-butadiene, or a combination thereof. In some embodiments, the conjugated diene is 1,3-butadiene.

The hydrogenated block copolymer can be a copolymer comprising (A) at least one block derived from an alkenyl aromatic compound and (B) at least one block derived from a conjugated diene, in which the aliphatic unsaturated group content in the block (B) is at least partially reduced by hydrogenation. In an aspect, the aliphatic unsaturation in the (B) block is reduced by at least 50 percent, or at least 70 percent. The arrangement of blocks (A) and (B) includes a linear structure, a grafted structure, and a radial teleblock structure with or without a branched chain. Linear block copolymers include tapered linear structures and non-tapered linear structures. In an aspect, the hydrogenated block copolymer has a tapered linear structure. In an aspect, the hydrogenated block copolymer has a non-tapered linear structure. In an aspect, the hydrogenated block copolymer comprises a (B) block that comprises random incorporation of alkenyl aromatic monomer. Linear block copolymer structures include diblock (A-B block), triblock (A-B-A block or B-A-B block), tetrablock (A-B-A-B block), and pentablock (A-B-A-B-A block or B-A-B-A-B block) structures as well as linear structures containing 6 or more blocks in total of (A) and (B), wherein the molecular weight of each (A) block can be the same as or different from that of other (A) blocks, and the molecular weight of each (B) block can be the same as or different from that of other (B) blocks. In an aspect, the hydrogenated block copolymer is a diblock copolymer, a triblock copolymer, or a combination thereof.

In an aspect, the hydrogenated block copolymer excludes the residue of monomers other than the alkenyl aromatic compound and the conjugated diene. In some embodiments, the hydrogenated block copolymer consists of blocks derived from the alkenyl aromatic compound and the conjugated diene. It does not comprise grafts formed from these or any other monomers. It also consists of carbon and hydrogen atoms and therefore excludes heteroatoms. In an aspect, the hydrogenated block copolymer includes the residue of one or more acid functionalizing agents, such as maleic anhydride. In an aspect, the hydrogenated block copolymer comprises a polystyrene-poly(ethylene-butylene)-polystyrene triblock copolymer, a polystyrene-poly(ethylene-propylene) diblock copolymer, or a combination thereof.

In an aspect, the hydrogenated block copolymer is a polystyrene-poly(ethylene-butylene)-polystyrene triblock copolymer having a polystyrene content of 25 to 35 weight percent, based on the weight of the polystyrene-poly(ethylene-butylene)-polystyrene triblock copolymer. In an aspect, the hydrogenated block copolymer is a polystyrene-poly(ethylene-propylene) diblock copolymer having a polystyrene content of 35 to 55 weight percent, based on the weight of the polystyrene-poly(ethylene-propylene) diblock copolymer.

Methods for preparing hydrogenated block copolymers are known in the art and many hydrogenated block copolymers are commercially available. Illustrative commercially available hydrogenated block copolymers include the polystyrene-poly(ethylene-propylene) diblock copolymers available from Kraton Performance Polymers Inc, as KRATON G1701 (having 37 weight percent polystyrene) and G1702 (having 28 weight percent polystyrene); the polystyrene-poly(ethylene-butylene)-polystyrene triblock copolymers available from Kraton Performance Polymers Inc. as KRATON G1641 (having 33 weight percent polystyrene), G1650 (having 30 weight percent polystyrene), G1651 (having 33 weight percent polystyrene), and G1654 (having 31 weight percent polystyrene); and the polystyrene-poly(ethylene-ethylene/propylene)-polystyrene triblock copolymers available from Kuraray as SEPTON S4044. S4055, S4077, and S4099. Additional commercially available hydrogenated block copolymers include polystyrene-poly(ethylene-butylene)-polystyrene (SEBS) triblock copolymers available from Dynasol as CALPRENE H6140 (having 31 weight percent polystyrene), H6170 (having 33 weight percent polystyrene), H6171 (having 33 weight percent polystyrene), and H6174 (having 33 weight percent polystyrene); and from Kuraray as SEPTON 8006 (having 33 weight percent polystyrene) and 8007 (having 30 weight percent polystyrene); polystyrene-poly(ethylene-propylene)-polystyrene (SEPS) copolymers available from Kuraray as SEPTON 2006 (having 35 weight percent polystyrene) and 2007 (having 30 weight percent polystyrene); and oil-extended compounds of these hydrogenated block copolymers available from Kraton Performance Polymers Inc. as KRATON G4609 (containing 45% mineral oil, and the SEBS having 33 weight percent polystyrene) and G4610 (containing 31% mineral oil, and the SEBS having 33 weight percent polystyrene); and from Asahi as TUFTEC H1272 (containing 36% oil, and the SEBS having 35 weight percent polystyrene). Mixtures of two of more hydrogenated block copolymers can be used. In some embodiments, the hydrogenated block copolymer comprises a polystyrene poly (ethylene-butylene)-polystyrene triblock copolymer having a weight average molecular weight of at least 100,000 grams per mole, or 200,000 to 400,000 grams per mole.

When present, the composition comprises the hydrogenated block copolymer in an amount of 0.1 to 10 weight percent, based on the total weight of the composition. Within this range, the hydrogenated block copolymer amount can be 0.5 to 10 weight percent, or 1 to 9 weight percent.

The composition can optionally minimize or exclude any component not specifically disclosed herein. For example, the composition can optionally minimize or exclude a thermoplastic polymer other than the polyamide, the polyphenylene ether, and the polyetherester amide. For example, the composition can comprise less than 10 weight percent, or less than 5 weight percent, or less than 1 weight percent, or less than 0.1 weight percent or exclude a thermoplastic polymer other than the polyamide, the polyphenylene ether, and the polyetherester amide. In an aspect, the composition can minimize or exclude a reinforcing filler. For example, the composition can comprise less than 10 weight percent, or less than 5 weight percent, or less than 1 weight percent, or less than 0.1 weight percent or exclude a reinforcing filler. The composition can exclude a reinforcing filler other that glass fibers. In an aspect, when a reinforcing filler is included in the composition, an impact modifier can be minimized or excluded from the composition (e.g., present in an amount of less than 5 weight percent, or less than I weight percent, or less than 0.1 weight percent or exclude an impact modifier). Conversely, in an aspect, when an impact modifier is present in the composition, a reinforcing filler can be minimized or excluded from the composition (e.g., present in an amount of less than 5 weight percent, or less than 1 weight percent, or less than 0.1 weight percent or exclude a reinforcing filler). In an aspect, the composition can minimize or exclude a conductive filler, for example a conductive carbon filler, for example conductive carbon black. In an aspect, the composition can minimize or exclude a monomeric or polymeric antistatic agent other than the polyetherester amide. In a specific aspect, the composition can exclude a vinyl polymer comprising a carboxyl group, an epoxy group, an amino group, a hydroxyl group, a polyalkylene oxide group, an oxazoline group, or a combination thereof.

The molded article comprising the composition of the present disclosure can exhibit one or more desirable properties. For example, the molded article can exhibit a heat deflection temperature of 120° C. or more, or 150° C. or more, determined according to ASTM D648. The molded article can exhibit a surface resistivity of 10⁸ ohm/sq to 10¹³ ohm/sq, or 10⁹ ohm/sq to 10¹³ ohm/sq determined according to ASTM D257. The composition can exhibit good dielectric properties. For example, the molded article can exhibit a dielectric constant less than 4, determined using QWED split post dielectric resonator and Agilent PNA network analyzer, as further described in the working examples below. The molded article can exhibit a parasitic capacitance of less than or equal to 0.2 pF, determined using a capacitor signal detector (e.g., model CAN11) at 100 kHz and 1 volt. The molded article can advantageously exhibit a light color. As used herein, the term “light color” means the molded article has an L* value of greater than 50 units, preferably greater than 70 units. Conversely, the term “dark color” means a molded article having an L* value of less than 50 units. L* refers to the CIELAB color scale, where L* represents the lightness of the color, where L*=0 is black and L*=100 is white. The L* value can be determined using a 10 degree observer and a D65 illuminant light source, and according to ASTMD2244. In an aspect, the molded article can have the desired white color without the use of a coloring agent or a pigment. In an aspect, the molded article can have a beat deflection temperature of 150° C. or more, determined according to ASTM D648 and is capable of withstanding online electrostatic painting.

Mechanical and processing properties of interest include, but are not limited to, notched and unnotched Izod impact strength (tested in accordance with ASTM D256), flexural modulus and flexural strength (tested in accordance with ASTM D790), and tensile modulus/strength/elongation (tested in accordance with ASTM D638), as further described in the working examples below. For example, the composition can exhibit a flexural modulus of 1200 MPa or more, determined according to ASTM D790. The molded article can exhibit a notched Izod impact strength of 30 J/m or more, determined according to ASTM D256 at 23° C. One or more of the foregoing properties can be exhibited by a molded sample of the composition. In an aspect, the molded article exhibits a heat deflection temperature of 120° C. or more, determined according to ASTM D648; a surface resistivity of 10⁸ ohm/sq to 10¹³ ohm/sq. determined according to ASTM D257; a dielectric constant less than 4, determined using QWED split post dielectric resonator and Agilent PNA network analyzer; a flexural modulus of 1200 MPa or more, determined according to ASTM D790; and a parasitic capacitance of less than or equal to 0.2 pF, determined using a capacitor signal detector at 100 kHz and 1 volt. In an aspect, the molded article can exhibit a heat deflection temperature of 160° C. or more, determined according to ASTM D648; a surface resistivity of 10° ohm/sq to 1013 ohm/sq, determined according to ASTM D257; a dielectric constant 2.5 to 3.5, determined using QWED split post dielectric resonator and Agilent PNA network analyzer; a flexural modulus of 1500 MPa or more, determined according to ASTM D790; a parasitic capacitance of less than or equal to 0.2 pF, determined using a capacitor signal detector at 100 kHz and I volt; a light color; and is capable of withstanding online electrostatic painting.

In a specific aspect, the molded article comprises a composition comprising 30 to 70 weight percent of the polyamide; 25 to 40 weight percent of the polyphenylene ether; 5 to 20 weight percent of the polyetherester amide; and optionally, 5 to 25 weight percent of a reinforcing filler; wherein the molded article exhibits: a heat deflection temperature of 160° C. or more, determined according to ASTM D648; a surface resistivity of 10⁹ ohm/sq to 10¹³ ohm/sq. determined according to ASTM D257; a dielectric constant 2.5 to 3.5, determined using QWED split post dielectric resonator and Agilent PNA network analyzer; a flexural modulus of 1500 MPa or more, determined according to ASTM D790; a parasitic capacitance of less than or equal to 0.2 pF, determined using a capacitor signal detector at 100 kHz and 1 volt; a light color; and is capable of withstanding online electrostatic painting. In an aspect, the polyamide comprises polyamide 6, polyamide 6,6, or a combination thereof; the polyphenylene ether comprises repeating units derived from 2,6-dimethyl phenol; the polyetherester amide comprises a polyamide 6 segment and a poly (ethylene oxide) segment; and when present, the reinforcing filler comprises glass fibers.

The composition can be prepared by melt-blending or melt-kneading the components of the composition. The melt-blending or melt-kneading can be performed using common equipment such as ribbon blenders, HENSCHEL™ mixers, BANBURY™ mixers, drum tumblers, single-screw extruders, twin-screw extruders, multi-screw extruders, co-kneaders, and the like. For example, the present composition can be prepared by melt-blending the components in a twin-screw extruder at a temperature of 245 to 310° C., or 260 to 310° C., or 280 to 300° C. An exemplary method is further described in the working examples below.

The molded articles comprising the composition can include automotive, electrical, and electronic components. In an aspect, the molded article is a component of a consumer electronic device. In an aspect, the molded article is an automotive component. Suitable methods of forming such articles include single layer and multilayer sheet extrusion, injection molding, blow molding, film extrusion, profile extrusion, pultrusion, compression molding, thermoforming, pressure forming, hydroforming, vacuum forming, and the like. Combinations of the foregoing article fabrication methods can be used.

In a specific aspect, the article is an automotive component, for example an exterior automotive component. Exterior automotive component as used herein refers to an automotive component that is provided for exterior appearance purposed or materially contributes to the exterior appearance of a vehicle. For example, exemplary automotive components can include a door cover, exterior trim, charger flap, or fender. Non-automotive applications are also contemplated, including appliance wall panels, both interior and exterior, for appliances including refrigerators and freezers; handles for appliances, equipment, or other articles; trays for refrigerators, freezers, or other articles; and storage boxes or shelves.

This disclosure is further illustrated by the following examples, which are non-limiting.

### EXAMPLES

Materials used for the following examples are described in Table 1.

TABLE 1

| Component | Description | Supplier |
|---|---|---|
| PA-1 | Polyamide-6,6, CAS Reg. No. 32131-17-2, having a melting point of 265° C.; | Invista |
| | obtained as U3600 | |
| PA-2 | Polyamide-6, CAS Reg. No. 25038-54-4, obtained as Ultramid B27 | BASF |
| PPE | Poly(2,6-dimethyl-1,4-phenylene ether), CAS Reg. No. 24938-67-8, having an | SABIC |
| | intrinsic viscosity of 0.46 deciliter per gram as measured in chloroform at 25° C. | |
| PAE-1 | Polyether ester amide having a refractive index of 1.51, and including a | Sanyo |
| | polyalkyleneoxide structure, and having a number-average molecular weight | Chemical |
| | (Mn) of 4,000 grams per mole as determined by ¹H NMR spectroscopy, obtained | Industries, |
| | as PELECTRON AS | Ltd. |
| PAE-2 | Polyether ester amide having a refractive index of 1.51, and including a | Sanyo |
| | polyalkyleneoxide structure, and having a number-average molecular weight | Chemical |
| | (Mn) of 4,000 grams per mole as determined by ¹H NMR spectroscopy, obtained | Industries, |
| | as PELESTAT 6500 | Ltd. |
| GF | Glass fibers having a diameter of 10.5 micrometers, a pre-compounded length of | Nippon |
| | 3.0 millimeters, and a surface treatment for compatibility with polyamide-6 and | Electric Glass |
| | polyamide-6,6; obtained as T-262H | Co., Ltd. |
| SEBS | High MW Polystyrene-poly(ethylene-butylene)-polystyrene block copolymer, | Kraton |
| | obtained as KRATON G1651-J | Performance |
| | | Polymers, Inc. |
| AO-1 | Octadecyl 3,5-di-tert-butyl-4-hydroxyhydrocinnamate, CAS Reg. No. 2082-79-3; | BASF |
| | obtained as IRGANOX 1076 | |
| AO-2 | Pentaerythritol 3-(4-hydroxy-3,5-di-tert-butylphenyl)propionate (1:4), CAS Reg. | BASF |
| | No. 6683-19-8; obtained as IRGANOX 1010 | |
| GMA | Styrene-acrylate copolymer with glycidyl groups, obtained as JONCRYL ADR | BASF |
| | 4368CS | |
| CA | Citric acid, CAS Reg. No. 77-92-9 | Jungbunzlauer |
| CCB | Conductive Carbon black, obtained as Vulcan XC605 | Cabot |

Compositions were compounded using a TEM-37BS compounder. All components were added at the feedthroat except polyamide and glass fiber and GMA, which were added downstream using a side feeder. The processing parameters used are summarized in Table 2.

TABLE 2

| Screw Design | L-2-1 | |
|---|---|---|
| Feed (Zone 0) Temp. | — | |
| Zone 1 Temp. | 50° | C. |
| Zone 2 Temp. | 150° | C. |
| Zone 3 Temp. | 240° | C. |
| Zone 4 Temp. | 250° | C. |
| Zone 5 Temp. | 250° | C. |
| Zone 6 Temp. | 250° | C. |
| Zone 7 Temp. | 255° | C. |
| Zone 8 Temp. | 255° | C. |
| Zone 9 Temp. | 255° | C. |
| Zone 10 Temp. | 255° | C. |
| Zone 11 Temp. | 255° | C. |
| Zone 12 Temp. | — | |
| Die Temp. | 255° | C. |
| Screw Speed | 350 | rpm |
| Throughput | 30 | kg/hr |
| Vacuum | −0.08 | bar |
| Side Feeder 1 speed | 250 | rpm |

Parts were molded using an UH1000-110 injection molding machine with temperature settings of 270-275-275-275° C. (from throat to nozzle) and a mold temperature of 75° C. Prior to molding the pellets were pre-dried at 110° C. for 2-4 hours.

Properties of the molded parts were tested according to the following standards.

Surface resistance and volume resistance were determined in accordance with ASTM D257 using a test specimen of 68 mm×68 mm×3 mm and an electric charge of 100V.

Dielectric constant (Dk) and dissipation factor (Df) were tested at 1.1 GHz using a QWED split post dielectric resonator and Agilent PNA network analyzer and a sample size 150*150*1.5 mm.

The heat deflection temperature (HDT) was determined in accordance with the ASTM D648 standard, using the flat side of 3.2 mm thick ASTM bars and a load of 0.45 MPa.

Notched Izod impact strength (NII), expressed in units of joules/meter, was measured according to ASTM D256 at 23° C. and −30° C. with a 5.5 Joule hammer and a 3.2-millimeter test bar,

Flexural properties were measured in accordance with ASTM D790 on molded samples having a thickness of 3.2 mm.

Tensile properties were determined in accordance with ASTM D638. Tensile stress at break, expressed in units of megapascals (MPa), tensile strain at break, expressed in units of percent, and modulus of elasticity, expressed in units of MPa, were measured at 23° C. using a test speed of 5 millimeters per minute.

Shrinkage performance was determined by measurement of the shrinkage from mold cavity dimensions to molded part dimensions using injection molded discs having a diameter of 100 mm and a thickness of 3.2 mm. Cross-flow (perpendicular to flow) and in-flow (parallel to flow) shrinkage are measured on 5 disks after conditioning at room temperature for 24 hours in a lab. The average shrinkage is reported out.

Water uptake was determined in accordance with ISO 62.

The appearance of each molded article was further assessed by visual inspection (e.g., by the naked eye).

Capacitor signal transfer was assessed by parasitic capacitance. A sample was rated as “pass” if the composition achieved a parasitic capacitance of less than or equal to 0.2 picofarad (pF). A sample was rated as “fail” if the composition achieved a parasitic capacitance of greater than 0.2 pF. Parasitic capacitance was determined using a capacitor signal detector model CAN11 at 100 kHz and 1 volt.

Molded samples of the compositions were also tested for the ability to withstand online electrostatic painting. A sample was rated as “pass” if the sample achieved a rating of 5B or better in a cross-hatch adhesion test according to ASTM 3359 and exhibited an HDT of at least 150° C. determined by ASTM D648. The flat side of 3.2 mm thick ASTM bar and a load of 0.45 MPa was used for testing. A sample was rated as “fail” if the sample was not able to achieve a rating of at least 5B in the cross-hatch adhesion test according to ASTM 3359 or if the sample exhibited an HDT of less than 150° C. determined by ASTM D648.

Compositions and properties are summarized in Table 3. The amount of each component is provided in weight percent based on the total weight of the composition.

TABLE 3

| | Unit | CE1 | E1 | E2 | E3 | E4 | E5 | E6 | E7 | E8 | E9 | E10 | E11 | E12 |
|---|---|---|---|---|---|---|---|---|---|---|---|---|---|---|
| Component | | | | | | | | | | | | | | |
| PA-1 | wt % | 51 | 45.85 | 40.32 | 32.02 | 32.02 | | 48.62 | 16 | 33.2 | 47.68 | 36 | 44 | 46.4 |
| PA-2 | wt % | | | | | 5 | 37.02 | | 32.6 | 15 | | 8 | | |
| PPE | wt % | 41.05 | 37.06 | 32.59 | 25.89 | 25.89 | 25.89 | 39.29 | 38.75 | 39.15 | 38.23 | 36.91 | 36.91 | 37.51 |
| PAE-1 | wt % | | 15 | 15 | 20 | 15 | 15 | | | | | | | |
| PAE-2 | wt % | | | | | | | 5 | 8 | 8 | 10 | 12 | 12 | 10 |
| GF | wt % | | | 10 | 20 | 20 | 20 | | | | | | | |
| SEBS | wt % | 5 | | | | | | 5 | 3 | 3 | 2 | 5 | 5 | 5 |
| AO-1 | wt % | 0.15 | 0.15 | 0.15 | 0.15 | 0.15 | 0.15 | 0.15 | 0.15 | 0.15 | 0.15 | 0.15 | 0.15 | 0.15 |
| AO-2 | wt % | 0.15 | 0.15 | 0.15 | 0.15 | 0.15 | 0.15 | 0.15 | 0.15 | 0.15 | 0.15 | 0.15 | 0.15 | 0.15 |
| GMA | wt % | | 1 | 1 | 1 | 1 | 1 | 1 | 0.75 | 0.75 | 1 | 1 | 1 | |
| CA | wt % | 0.65 | 0.79 | 0.79 | 0.79 | 0.79 | 0.79 | 0.79 | 0.6 | 0.79 | 0.79 | 0.79 | 0.79 | 0.79 |
| CCB | wt % | 2 | | | | | | | | | | | | |
| Properties | | | | | | | | | | | | | | |
| Surf. Resist. | ohm/ | 3.3 × | 1.2 × | 9.6 × | 1.7 × | 7.5 × | 5.7 × | 7.2 × | 9 × | 6.3 × | 5.4 × | 1.3 × | 2.4 × | 3.5 × |
| | square | 10¹⁰ | 10¹¹ | 10¹⁰ | 10¹⁰ | 10¹⁰ | 10¹⁰ | 10¹² | 10¹¹ | 10¹¹ | 10¹¹ | 10¹¹ | 10¹¹ | 10¹² |
| Vol. Resist. | ohm- | 9.5 × | 9.75 × | 1 × | 1.4 × | 5.9 × | 6.1 × | 2.2 × | 3.3 × | 3 × | 2.2 × | 1.3 × | 1.6 × | 5.5 × |
| | cm | 10⁹ | 10⁹ | 10¹⁰ | 10⁹ | 10⁹ | 10⁹ | 10¹¹ | 10¹⁰ | 10¹⁰ | 10¹⁰ | 10¹⁰ | 10¹⁰ | 10¹⁰ |
| HDT | ° C. | 193 | 150 | 196 | 196 | 209 | 186 | 175 | 137 | 148 | 150 | 137 | 141 | 182 |
| Dk @ 1.1 GHz | | 20.1 | 2.9 | 3 | 3.3 | 3.3 | 3.3 | 2.8 | 2.9 | 2.9 | 2.9 | 2.9 | 2.9 | 2.9 |
| NII, 23° C. | J/m | 90 | 100 | 69.2 | 123 | 97.3 | 134 | 39 | 63 | 53 | 58 | 120 | 107 | 54 |
| NII, −30° C. | J/m | 56 | 75.6 | 40.5 | 54.8 | 46.4 | 62.2 | 35 | 49 | 39 | 46 | 80 | 80 | 37 |
| Flex. Mod. | MPa | 2400 | 1040 | 1750 | 2640 | 2600 | 2350 | 2000 | 1310 | 1350 | 1500 | 1250 | 1310 | 1780 |
| Flex. Stress @ | MPa | 85 | 45.3 | 52.7 | 62.1 | 60.9 | 60.1 | 81 | 60 | 61 | 61 | 53 | 55 | 49 |
| yield | | | | | | | | | | | | | | |
| Mod. of | MPa | 2100 | 1359 | 2407 | 3337 | 3424 | 3149 | 2201 | 1639 | 1635 | 1893 | 1497 | 1661 | 1913 |
| elasticity | | | | | | | | | | | | | | |
| Stress @ brk | MPa | 60 | 29.8 | 30.1 | 39 | 39.5 | 35.2 | 53 | 36 | 35 | 37 | 36 | 37 | 29 |
| Elong. @ brk | % | 33 | 8.8 | 4.7 | 2.8 | 4.1 | 3 | 5.2 | 6.8 | 5.3 | 4.8 | 13.8 | 11.2 | 2.4 |
| Shrinkage, | % | 1.6 | 0.69 | 0.44 | 0.23 | 0.18 | 0.09 | 1.18 | 0.79 | 0.89 | 1.17 | 0.97 | 1.08 | 1.16 |
| flow | | | | | | | | | | | | | | |
| Shrinkage, | % | 1.3 | 0.85 | 0.6 | 0.39 | 0.47 | 0.31 | 1.1 | 0.88 | 0.98 | 1.14 | 1.08 | 1.08 | 1.14 |
| x-flow | | | | | | | | | | | | | | |
| Water uptake | % | 0.55 | 0.38 | 0.38 | 0.46 | 0.36 | 0.42 | 0.21 | 0.34 | 0.33 | 0.23 | 0.35 | 0.32 | 0.3 |
| Appear. | | dark | light | near | near | near | near | near | near | near | near | near | near | near |
| | | black | brown | white | white | white | white | white | white | white | white | white | white | white |
| Capacitor | | Fail | Pass | Pass | Pass | Pass | Pass | Pass | Pass | Pass | Pass | Pass | Pass | Pass |
| signal | | | | | | | | | | | | | | |
| transfer | | | | | | | | | | | | | | |
| Online | | Pass | Fail | Pass | Pass | Pass | Pass | Pass | Fail | Fail | Fail | Fail | Fail | Pass |
| electrostatic | | | | | | | | | | | | | | |
| coating | | | | | | | | | | | | | | |

As shown in Table 3, each of examples E1-E5 exhibited a similar conductivity compared to the composition of comparative example CE1, which included carbon black. As further shown in Table 3, the heat resistance and mechanical strength of the composition could be further improved by addition of reinforcing fillers such as glass fibers. Furthermore, each of examples E1-E12 achieved a parasitic capacitance of less than or equal to 0.2 pF. In a further advantageous feature, each of the compositions of examples E2-E6 and E12 exhibited an HDT of greater that 150° C. and achieved a rating of at least 5B in a cross-hatch adhesion test and were therefore capable of withstanding an online electrostatic coating process (i.e., rated as “pass” in Table 3). A significant improvement is therefore provided by the present disclosure.

This disclosure further encompasses the following aspects.
Aspect 1: A molded article comprising a composition comprising: 25 to 77 weight percent of a polyamide; 20 to 45 weight percent of a polyphenylene ether; 3 to 30 weight percent of a polyetherester amide; wherein weight percent of each component is based on the total weight of the composition; wherein the molded article is an automotive component; and wherein the molded article exhibits: a heat deflection temperature of 120° C. or more, determined according to ASTM D648; a surface resistivity of 10⁸ ohm/sq to 10¹³ ohm/sq, determined according to ASTM D257; a dielectric constant less than 4, determined using QWED split post dielectric resonator and Agilent PNA network analyzer; a flexural modulus of 1200 MPa or more, determined according to ASTM D790; and a parasitic capacitance of less than or equal to 0.2 pF, determined using a capacitor signal detector at 100 kHz and 1 volt.
Aspect 2: The molded article of aspect 1, wherein the molded article has a light color, preferably wherein the molded article exhibits a CIE lightness value L* value of greater than 50 units, or greater than 70 units, as determined according to ASTM D2244 using a 10 degree observer and a D65 illuminant light source.
Aspect 3: The molded article of aspect 1 or 2, wherein the molded article has a heat deflection temperature of 150° C. or more, determined according to ASTM D648; and is capable of withstanding an online electrostatic painting process at a temperature of 150° C. or more.
Aspect 4: The molded article of any of aspects 1 to 3, wherein the polyamide comprises polyamide 6, polyamide 6,6, polyamide 6,10, polyamide 10,10, polyamide 9T, polyamide 6T, polyamide 10T, polyamide 61, polyamide MXD6, or a combination thereof.
Aspect 5: The molded article of any of aspects 1 to 4, wherein the polyphenylene ether comprises repeating units derived from 2,6-dimethyl phenol.
Aspect 6: The molded article of any of aspects 1 to 5, wherein the polyetherester amide comprises a hard segment comprising a polyamide and a soft segment comprising a polyalkylene oxide, preferably wherein the polyetherester amide comprises a polyamide 6 segment and a poly (ethylene oxide) segment.
Aspect 7: The molded article of any of aspects 1 to 6, wherein the composition further comprises 5 to 30 weight percent of a reinforcing filler, preferably wherein the reinforcing filler comprises glass fibers.
Aspect 8: The molded article of any of aspects 1 to 7, wherein the composition further comprises an additive composition, preferably wherein the additive composition comprises a compatibilizer, an antioxidant, or a combination thereof.
Aspect 9: The molded article of any of aspects 1 to 8, wherein the composition comprises 40 to 60 weight percent of the polyamide; 35 to 45 weight percent of the polyphenylene ether; and 5 to 17 weight percent of the polyetherester amide.
Aspect 10: The molded article of any of aspects 1 to 8, wherein the composition comprises 30 to 60 weight percent of the polyamide; 25 to 35 weight percent of the polyphenylene ether; 10 to 25 weight percent of the polyetherester amide; and 5 to 25 weight percent of a reinforcing filler.
Aspect 11: The molded article of any of aspects 1 to 8, wherein the composition comprises 30 to 70 weight percent of the polyamide; 25 to 40 weight percent of the polyphenylene ether; 5 to 20 weight percent of the polyetherester amide; and optionally. 5 to 25 weight percent of a reinforcing filler; wherein the molded article exhibits: a heat deflection temperature of 160° C. or more, determined according to ASTM D648; a surface resistivity of 109 ohm/sq to 1013 ohm/sq, determined according to ASTM D257; a dielectric constant 2.5 to 3.5, determined using QWED split post dielectric resonator and Agilent PNA network analyzer; a flexural modulus of 1500 MPa or more, determined according to ASTM D790; a parasitic capacitance of less than or equal to 0.2 pF, determined using a capacitor signal detector at 100 KHz and 1 volt; a CIE lightness value L* value of greater than 50 units, or greater than 70 units, as determined according to ASTM D2244 using a 10 degree observer and a D65 illuminant light source; and is capable of withstanding an online electrostatic painting process at a temperature of 150° C. or more.
Aspect 12: The molded article of aspect 11, wherein the polyamide comprises polyamide 6, polyamide 6,6, or a combination thereof; the polyphenylene ether comprises repeating units derived from 2,6-dimethyl phenol; the polyetherester amide comprises a polyamide 6 segment and a poly (ethylene oxide) segment; and when present, the reinforcing filler comprises glass fibers.
Aspect 13: The molded article of any of aspects 1 to 12, wherein a conductive filler is excluded from the composition, preferably wherein carbon black is excluded from the composition.
Aspect 14: The molded article of any of aspects 1 to 13, wherein the composition comprises a continuous phase comprising the polyamide and the polyetherester amide and a dispersed phase comprising the polyphenylene ether.
Aspect 15: The molded article of any of aspects 1 to 14, wherein the automotive component is a door cover, charger flap, or fender.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other. “Combinations” is inclusive of blends, mixtures, alloys, reaction products, and the like. The terms “first.” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “an aspect” means that a particular element described in connection with the aspect is included in at least one aspect described herein, and may or may not be present in other aspects. The term “combination thereof” as used herein includes one or more of the listed elements, and is open, allowing the presence of one or more like elements not named. In addition, it is to be understood that the described elements may be combined in any suitable manner in the various aspects.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group.

As used herein, the term “hydrocarbyl”, whether used by itself, or as a prefix, suffix, or fragment of another term, refers to a residue that contains only carbon and hydrogen. The residue can be aliphatic or aromatic, straight-chain, cyclic, bicyclic, branched, saturated, or unsaturated. It can also contain combinations of aliphatic, aromatic, straight chain, cyclic, bicyclic, branched, saturated, and unsaturated hydrocarbon moieties. However, when the hydrocarbyl residue is described as substituted, it may, optionally, contain heteroatoms over and above the carbon and hydrogen members of the substituent residue. Thus, when specifically described as substituted, the hydrocarbyl residue can also contain one or more carbonyl groups, amino groups, hydroxyl groups, or the like, or it can contain heteroatoms within the backbone of the hydrocarbyl residue. The term “alkyl” means a branched or straight chain, saturated aliphatic hydrocarbon group, e.g., methyl, ethyl, n-propyl, i-propyl, n-butyl, s-butyl, t-butyl, n-pentyl, s-pentyl, and n- and s-hexyl. “Alkenyl” means a straight or branched chain, monovalent hydrocarbon group having at least one carbon-carbon double bond (e.g., ethenyl (—HC═CH₂)). “Alkoxy” means an alkyl group that is linked via an oxygen (i.e., alkyl-O—), for example methoxy, ethoxy, and sec-butyloxy groups. “Alkylene” means a straight or branched chain, saturated, divalent aliphatic hydrocarbon group (e.g., methylene (—CH₂—) or, propylene (—(CH₂)₃—)). “Cycloalkylene” means a divalent cyclic alkylene group, —CₙH₂ₙ₋ₓ, wherein x is the number of hydrogens replaced by cyclization(s). “Cycloalkenyl” means a monovalent group having one or more rings and one or more carbon-carbon double bonds in the ring, wherein all ring members are carbon (e.g., cyclopentyl and cyclohexyl). “Aryl” means an aromatic hydrocarbon group containing the specified number of carbon atoms, such as phenyl, tropone, indanyl, or naphthyl. “Arylene” means a divalent aryl group. “Alkylarylene” means an arylene group substituted with an alkyl group. “Arylalkylene” means an alkylene group substituted with an aryl group (e.g., benzyl). The prefix “halo” means a group or compound including one more of a fluoro, chloro, bromo, or iodo substituent. A combination of different halo atoms (e.g., bromo and fluoro), or only chloro atoms can be present. The prefix “hetero” means that the compound or group includes at least one ring member that is a heteroatom (e.g., 1, 2, or 3 heteroatom(s)), wherein the heteroatom(s) is each independently N, O, S, Si, or P. “Substituted” means that the compound or group is substituted with at least one (e.g., 1, 2, 3, or 4) substituents that can each independently be a C₁₋₉ alkoxy, a C₁₋₉ haloalkoxy, a nitro (—NO₂), a cyano (—CN), a C₁₋₆ alkyl sulfonyl (—S(═O)₂-alkyl), a C₆₋₁₂ aryl sulfonyl (—S(═O)₂-aryl), a thiol (—SH), a thiocyano (—SCN), a tosyl (CH₃C₆H₄SO₂—), a C₃₋₁₂ cycloalkyl, a C₂₋₁₂ alkenyl, a C₅₋₁₂ cycloalkenyl, a C₆₋₁₂ aryl, a C₇₋₁₃ arylalkylene, a C₄₋₁₂ heterocycloalkyl, and a C₃₋₁₂ heteroaryl instead of hydrogen, provided that the substituted atom's normal valence is not exceeded. The number of carbon atoms indicated in a group is exclusive of any substituents. For example —CH₂CH₂CN is a C₂ alkyl group substituted with a nitrile.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A molded article comprising a composition comprising:
25 to 77 weight percent of a polyamide;
20 to 45 weight percent of a polyphenylene ether;
3 to 30 weight percent of a polyetherester amide;
wherein weight percent of each component is based on the total weight of the composition;
wherein the molded article is an automotive component; and
wherein the molded article exhibits:
a heat deflection temperature of 120° C. or more, determined according to ASTM D648;
a surface resistivity of 10⁸ ohm/sq to 10¹³ ohm/sq, determined according to ASTM D257;
a dielectric constant less than 4, determined using QWED split post dielectric resonator and Agilent PNA network analyzer;
a flexural modulus of 1200 MPa or more, determined according to ASTM D790; and
a parasitic capacitance of less than or equal to 0.2 pF, determined using a capacitor signal detector at 100 kHz and 1 volt.

2. The molded article of claim 1, wherein the molded article has a light color, wherein the molded article exhibits a CIE lightness value L* value of greater than 50 units, or greater than 70 units, as determined according to ASTM D2244 using a 10 degree observer and a D65 illuminant light source.

3. The molded article of claim 1, wherein the molded article
has a heat deflection temperature of 150° C. or more, determined according to ASTM D648; and
is capable of withstanding an online electrostatic painting process at a temperature of 150° C. or more.

4. The molded article of claim 1, wherein the polyamide comprises polyamide 6, polyamide 6,6, polyamide 6,10, polyamide 10,10, polyamide 9T, polyamide 6T, polyamide 10T, polyamide 6I, polyamide MXD6, or a combination thereof.

5. The molded article of claim 1, wherein the polyphenylene ether comprises repeating units derived from 2,6-dimethyl phenol.

6. The molded article of claim 1, wherein the polyetherester amide comprises a hard segment comprising a polyamide and a soft segment comprising a polyalkylene oxide.

7. The molded article of claim 1, wherein the composition further comprises 5 to 30 weight percent of a reinforcing filler.

8. The molded article of claim 1, wherein the composition further comprises an additive composition, wherein the additive composition comprises a compatibilizer, an antioxidant, or a combination thereof.

9. The molded article of claim 1, wherein the composition comprises
40 to 60 weight percent of the polyamide;
35 to 45 weight percent of the polyphenylene ether; and
5 to 17 weight percent of the polyetherester amide.

10. The molded article of claim 1, wherein the composition comprises
30 to 60 weight percent of the polyamide;
25 to 35 weight percent of the polyphenylene ether;
10 to 25 weight percent of the polyetherester amide; and
5 to 25 weight percent of a reinforcing filler.

11. The molded article of claim 1, wherein the composition comprises
30 to 70 weight percent of the polyamide;
25 to 40 weight percent of the polyphenylene ether;
5 to 20 weight percent of the polyetherester amide; and
optionally, 5 to 25 weight percent of a reinforcing filler;
wherein the molded article exhibits:
a heat deflection temperature of 160° C. or more, determined according to ASTM D648;
a surface resistivity of 10⁹ ohm/sq to 10¹³ ohm/sq, determined according to ASTM D257;
a dielectric constant 2.5 to 3.5, determined using QWED split post dielectric resonator and Agilent PNA network analyzer;
a flexural modulus of 1500 MPa or more, determined according to ASTM D790;
a parasitic capacitance of less than or equal to 0.2 pF, determined using a capacitor signal detector at 100 kHz and 1 volt;
a CIE lightness value L* value of greater than 50 units, or greater than 70 units, as determined according to ASTM D2244 using a 10 degree observer and a D65 illuminant light source; and
is capable of withstanding an online electrostatic painting process at a temperature of 150° C. or more.

12. The molded article of claim 11, wherein
the polyamide comprises polyamide 6, polyamide 6,6, or a combination thereof;
the polyphenylene ether comprises repeating units derived from 2,6-dimethyl phenol;
the polyetherester amide comprises a polyamide 6 segment and a poly (ethylene oxide) segment; and
when present, the reinforcing filler comprises glass fibers.

13. The molded article of claim 1, wherein a conductive filler is excluded from the composition.

14. The molded article of claim 1, wherein the composition comprises a continuous phase comprising the polyamide and the polyetherester amide and a dispersed phase comprising the polyphenylene ether.

15. The molded article of claim 1, wherein the automotive component is a door cover, charger flap, or fender.
